(19) United States
(12) Patent Application Publication
(10) Pub. No.: US 2012/0160428 A1
(43) Pub. Date: Jun. 28, 2012

(54) GUIDE RAIL DEVICE OF VEHICLE REAR WINDOW BLIND ASSEMBLY

(75) Inventor: Paul Lin, Tainan City (TW)

(73) Assignee: MACAUTO INDUSTRIAL CO., LTD., Tainan City (TW)

(21) Appl. No.: 13/297,910

(22) Filed: Nov. 16, 2011

(30) Foreign Application Priority Data
Dec. 27, 2010 (TW) 099225129

(51) Int. Cl. E06B 9/17

(52) U.S. Cl. 160/266

(57) ABSTRACT

A guide rail device includes a guide rail and a connecting seat. The guide rail is adapted to be disposed in an inner surface of a C-column, and has an elongated tube body and a first connection disposed at a bottom of the elongated tube body. The connecting seat is disposed below the elongated tube body, and has a tubular seat body adapted to be disposed at one end of a winding shaft, and a second connection provided on the tubular seat body. One of the first and second connections is configured as a socket body, and the other one of the first and second connections is configured as a bent leg fitted in the socket body.

### CROSS-REFERENCE TO RELATED APPLICATION

This application claims priority of Taiwanese Patent Application No. 099225129, filed on Dec. 27, 2010.

### BACKGROUND OF THE INVENTION

1. Field of the Invention

This invention relates to a guide rail device of a vehicle rear window blind assembly, and more particularly to a guide rail device of a vehicle rear window blind assembly that can be easily and quickly assembled.

2. Description of the Related Art

Referring to FIG. 1, a conventional vehicle rear window blind assembly 1 generally includes a winding shaft 11 disposed rotatably below a rear window shelf 3, two fixed seats 12 respectively provided on two opposite ends of the winding shaft 11, two guide rails 13 respectively disposed in inner surfaces of two confronting C-columns 5, a movable rod 14, a blind 15, two drive rods 16, and a power unit 17. Each guide rail 13 extends from a top edge of a vehicle rear window (not shown) to a position below the rear window shelf 3, and is connected to a respective one of the fixed seats 12. The movable rod 14 has two opposite ends connected respectively to the guide rails 13, and is movable upward and downward between the rear window shelf 3 and the top edge of the vehicle rear window. The blind 15 has a topside connected to the movable rod 14, and a bottom side extending beyond the rear window shelf 3 to connect with the winding shaft 11. Each drive rod 16 extends through the respective fixed seat 12, and is slidable on the respective guide rail 13 to move the movable rod 14. The power unit 17 drives the two drive rods 16 to slide upward and downward.

However, during assembly of the aforesaid guide rails 13, an insert portion 131 of each guide rail 13 is first inserted fixedly into an insert portion 121 of the respective fixed seat 12, after which each guide rail 13 is disposed in a mounting groove of the inner surface of the respective C-column 5.

For manufacturers, the aforesaid guide rails 13 must be easily and quickly assembled and positioned to conform to their requirements. The applicant makes a structural improvement on a connection between the guide rails and the winding shaft of the vehicle rear window blind assembly so that the connection between the same is easy, quick and stable.

### SUMMARY OF THE INVENTION

Therefore, the object of the present invention is to provide a guide rail device of a vehicle rear window blind assembly that can be easily and quickly assembled and positioned.

According to this invention, a guide rail device of a vehicle rear window blind assembly comprises a guide rail and a connecting seat . The guide rail is adapted to be disposed in an inner surface of a C-column, and has an elongated tube body and a first connection disposed at a bottom of the elongated tube body. The connecting seat is disposed below the elongated tube body, and has a tubular seat body adapted to be disposed at one end of a winding shaft, and a second connection provided on the tubular seat body. One of the first and second connections is configured as a socket body, and the other one of the first and second connections is configured as a bent leg fitted in the socket body.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a structural view of a conventional vehicle rear window blind assembly;

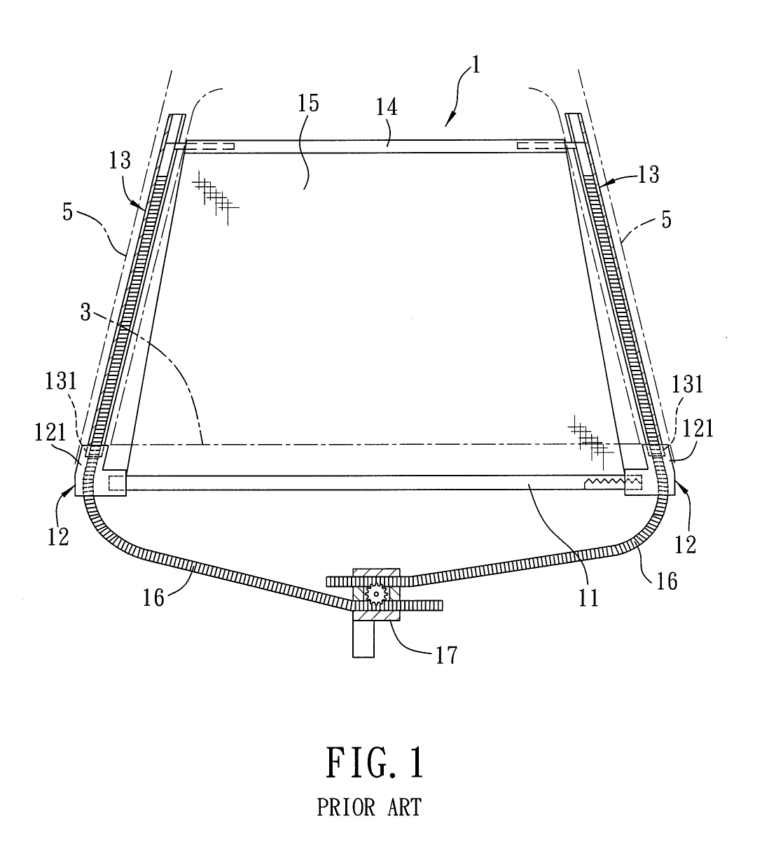

FIG. 2 is a fragmentary sectional view of a guide rail device of a vehicle rear window blind assembly according to the first preferred embodiment of this invention, illustrating how a guide rail connects with a connecting seat;

FIG. 3 is a view similar to FIG. 2, but with the guide rail connected to the connecting seat; and

FIG. 4 is a fragmentary sectional view of a guide rail device of a vehicle rear window blind assembly according to the second preferred embodiment of this invention.

### DETAILED DESCRIPTION OF THE PREFERRED EMBODIMENTS

The above-mentioned and other technical contents, features, and effects of this invention will be clearly presented from the following detailed description of two preferred embodiments in coordination with the reference drawings.

Before this invention is described in greater detail, it should be noted that, in the following description, similar elements are designated by the same reference numerals.

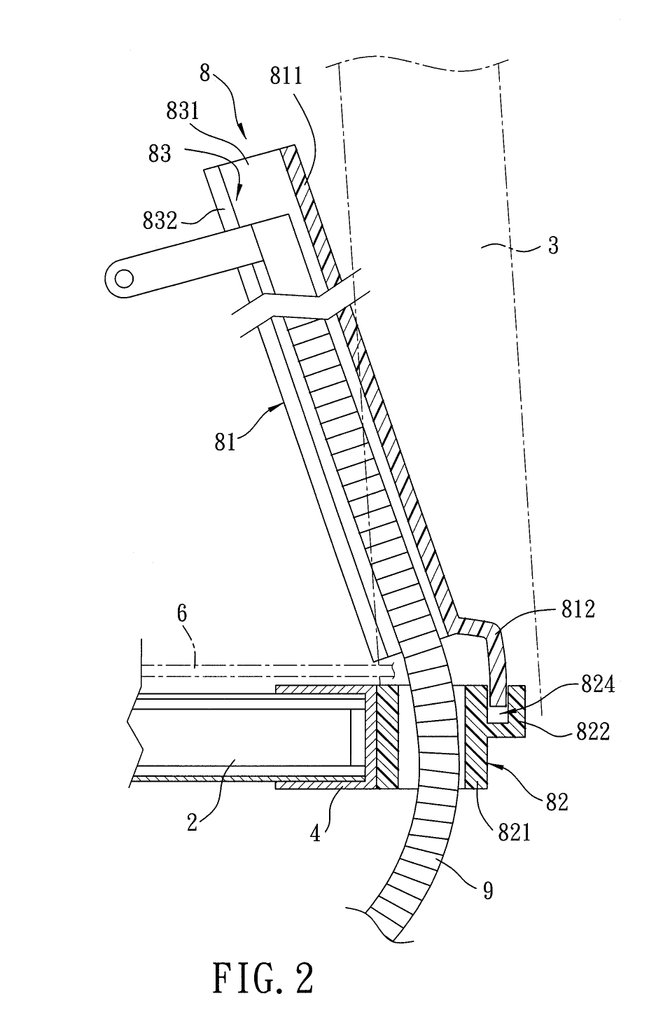

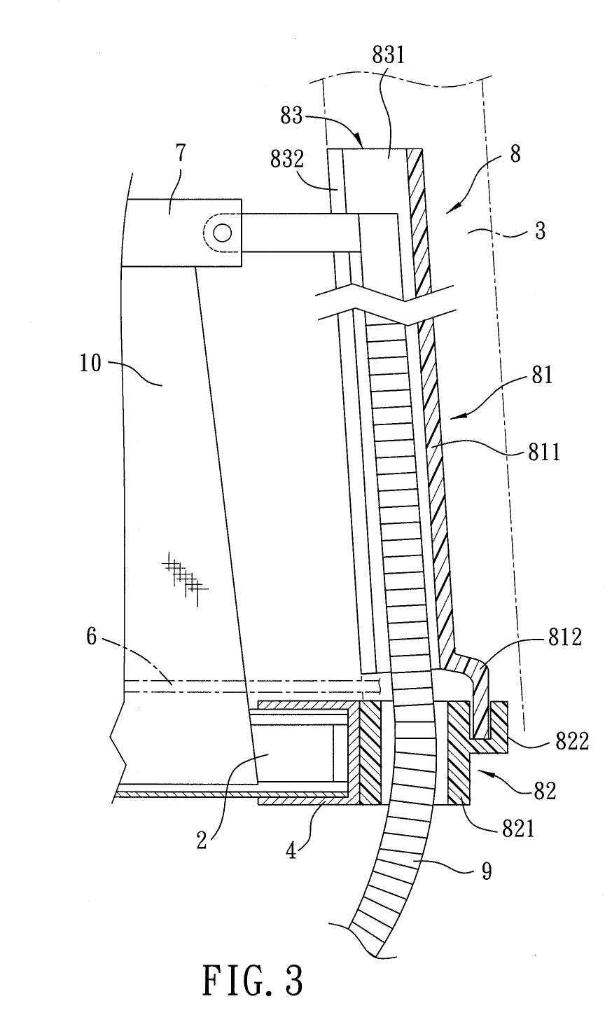

FIGS. 2 and 3 illustrate a guide rail device 8 of a vehicle rear window blind assembly according to the first preferred embodiment of this invention. The vehicle rear window blind assembly includes a winding shaft 2 disposed rotatably below a rear window shelf 6, two fixed seats 4 (only one is shown) respectively disposed on two opposite ends of the winding shaft 2, two guide rail devices 8 (only one is shown) of the present invention respectively disposed in inner surfaces of two confronting C-columns 3 (only one is shown), a movable rod 7, a blind 10, two drive rods 9 (only one is shown), and a power unit (not shown) . Each guide rail device 8 extends from a top end of a vehicle rear window (not shown) to a position below the rear window shelf 6, and is connected to a respective one of the fixed seats 4. The movable rod 7 has two opposite ends connected respectively to the guide rail devices 8, and is movable upward and downward between the rear window shelf 6 and the top end of the vehicle rear window. The blind 10 has a top side connected to the movable rod 7, and a bottom side extending beyond the rear window shelf 6 to connect with the winding shaft 2. Each drive rod 9 is slidable on the respective guide rail device 8 to move the movable rod 7. The power unit drives the two drive rods 9 to slide upward and downward. Since the drawings only illustrate one of the guide rail devices 8 of the vehicle rear window blind assembly of the present invention and the partial structures of the related components, only one of the guide rail devices 8 and the partial structures of the related components will be described hereinafter.

The guide rail device 8 comprises a guide rail 81 and a connecting seat 82. The guide rail 81 is disposed in the inner surface of one of the C-columns 3, and extends from the top end of the vehicle rear window to the position below the rear window shelf 6. The guide rail 81 has an elongated tube body 811 located above the rear window shelf 6. The elongated tube body 811 defines a channel 83, and has a slit opening 832 that extends along the length thereof, that communicates with the channel 83, and that faces the blind 10. The movable rod 7 has one end inserted into the channel 83 via the slit opening 832 to connect with the corresponding drive rod 9.

The guide rail 81 further has a first connection 812. In this embodiment, the first connection 812 is configured as a bent leg that extends downwardly and integrally from a bottom of the elongated tube body 811 to a level below the rear window shelf 6 and that is disposed oppositely of the slit opening 832.

The connecting seat 82 is disposed below the rear window shelf 6, and has a tubular seat body 821 connected to the corresponding fixed seat 4, and a second connection 822 disposed distally from one end of the fixed seat 4. In this embodiment, the second connection 822 is configured as a socket body that projects outwardly and radially from the tubular seat body 821 and that has a receiving slot 824 opening upwardly. The first connection or bent leg 812 is inserted into the receiving slot 824 in a top-to-bottom direction.

During assembly of the guide rail device 8, the guide rail 81 is first disposed inclinedly, as shown in FIG. 2, so as to facilitate accurate insertion of a bottom end of the bent leg 812 into the receiving slot 824 of the second connection or socket body 822. Afterwards, the guide rail 81 is pushed inwardly so as to be installed and fixed to the inner surface of the C-column 3, as shown in FIG. 3, causing the bent leg 812 to deform and be inserted fully into the receiving slot 824 of the socket body 822. At this time, the guide rail 81 and the connecting seat 82 are stably fixed to each other. Thus, assembly and positioning of the guide rail device 8 of the present invention can be accomplished in a quick and simple manner.

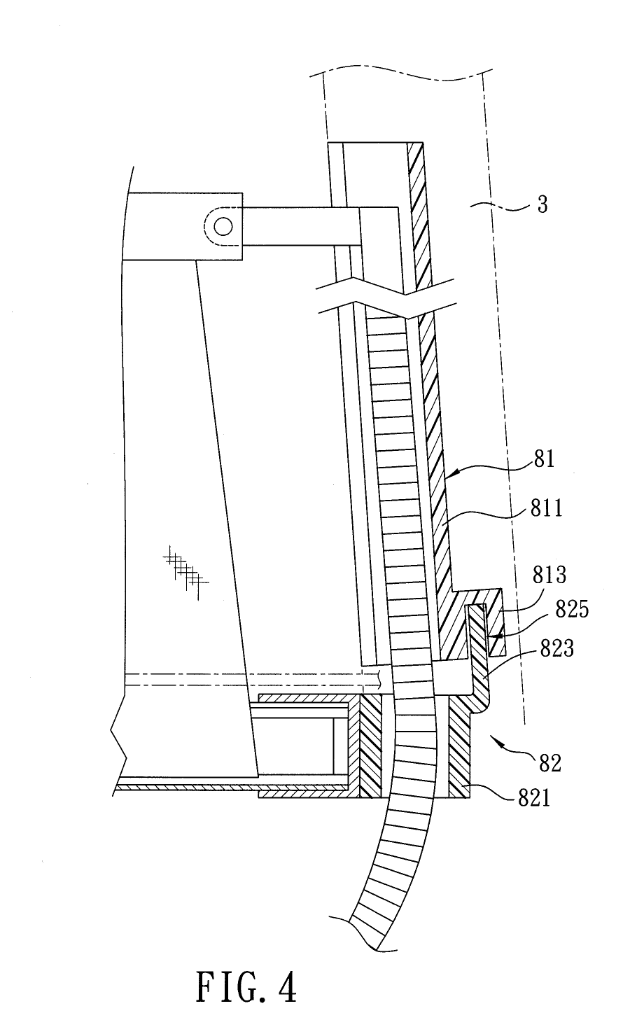

Referring to FIG. 4, a guide rail device 8 of a vehicle rear window blind assembly according to the second preferred embodiment of this invention is shown to be similar to the first preferred embodiment. However, in this embodiment, the structures of the first and second connections are interchanged. That is, the first connection 813 of the guide rail 81 is configured as a socket body that projects outwardly and radially from the elongated tube body 811 and that has a receiving slot 825 opening downwardly. The second connection 823 of the connecting seat 82 is configured as a bent leg that extends upwardly and integrally from a top of the tubular seat body 821 to a level above the rear window shelf 6 and that is inserted into the receiving slot 825.

Similarly, assembly and positioning of the guide rail device 8 of the present invention can be accomplished in a quick and simple manner using the second preferred embodiment.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A guide rail device of a vehicle rear window blind assembly, comprising:
a guide rail adapted to be disposed in an inner surface of a C-column and having an elongated tube body and a first connection disposed at a bottom of said elongated tube body; and
a connecting seat disposed below said elongated tube body and having a tubular seat body adapted to be disposed at one end of a winding shaft, and a second connection provided on said tubular seat body;
wherein one of said first and second connections is configured as a socket body, and the other one of said first and second connections is configured as a bent leg fitted in said socket body.

2. The guide rail device of claim 1, wherein said elongated tube body defines a channel and has a slit opening communicating with said channel, said first connection being disposed oppositely of said slit opening, said second connection being adapted to be disposed distally from said one end of the winding shaft.

3. The guide rail device of claim 2, wherein said first connection is configured as said bent leg that extends downwardly from said bottom of said elongated tube body, and said second connection is configured as said socket body that projects outwardly and radially from said tubular seat body and that has a receiving slot opening upwardly to receive said bent leg.

4. The guide rail device of claim 2, wherein said second connection is configured as said bent leg that extends upwardly from a top of said tubular seat body, and said first connection is configured as said socket body that projects outwardly and radially from said elongated tube body and that has a receiving slot opening downwardly to receive said bent leg.
